(19) United States
(12) Patent Application Publication
(10) Pub. No.: US 2004/0110050 A1
(43) Pub. Date: Jun. 10, 2004

(54) Environmentally friendly and inexpensive dielectric coolant for fuel cell stacks

(76) Inventors: Mahmoud H. Abd Elhamid, Warren, MI (US); Youssef Morcos Mikhail, Sterling Heights, MI (US); Richard H. Blunk, Macomb Township, MI (US); Daniel John Lisi, Eastpointe, MI (US); Shehdeh Jodeh, Windsor (CA)

Correspondence Address: CARY W. BROOKS, General Motors Corporation, Legal Staff, Mail Code 482-C23-B21, P.O. Box 300, Detroit, MI, 48265-3000, US

(21) Appl. No.: 10/315,924

(22) Filed: Dec. 9, 2002

(51) Int. Cl. H01M 8/04

(52) U.S. Cl. 429/26

(57) ABSTRACT

An environmentally friendly and inexpensive dielectric coolant for fuel cell stacks. The present invention is directed to a fuel cell, a system, and a method of cooling a fuel cell. The fuel cell is configured to react fuel with oxygen to generate an electric current and at least one reaction product and comprises an electrochemical catalytic reaction cell configured to include a fuel flowpath, an oxygen flowpath, and a coolant flowpath fluidly decoupled from the fuel flowpath and the oxygen flowpath. The coolant flowpath defines a coolant isolation manifold that includes a fluid dielectric coolant comprising a vegetable oil-based dielectric fluid. It is emphasized that this abstract is provided to comply with the rules requiring an abstract, which will allow a searcher or other reader to quickly ascertain the subject matter of the technical disclosure. It is submitted with the understanding that it will not be used to interpret or limit the scope or meaning of the claims. 37 C.F.R. §1.72(b).

### BACKGROUND OF THE INVENTION

The present invention relates generally to liquid cooled fuel cells and, more particularly, to a fuel cell, a system, and a method of cooling a fuel cell.

### SUMMARY OF THE INVENTION

Fuel cells rely on hydrogen oxidation and oxygen reduction to produce electrical energy. The byproduct of these catalytic reactions is water. Thermodynamically, the oxidation of hydrogen fuel at an anode and the reduction of oxygen at a cathode, both the anode and the cathode located within a fuel cell, should give a cell potential of about 1.23V. However, the actual measured value is typically around 1 V. This difference in cell voltage is due primarily to the slow kinetics of the cathode, which amounts to an almost 200 mV loss in cell voltage. The result of this loss in cell voltage is an expression of excess heat within the fuel cell. The removal of such excess heat is essential to increasing the useful lifetime of the fuel cell components.

As multiple fuel cells are arranged in a stack to increase electrical output, heat generation becomes significantly high. Consequently, in order to remove such excess heat, a coolant is employed that has a high heat capacity and which is physically stable at a temperature between about −40° C. and about 140° C. Aqueous coolants used with conventional combustion engine vehicles fall within this range and typically comprise a mixture of ethylene glycol and water. However, the design of today's fuel cell stacks requires that the coolant be substantially non-conducting (dielectric). If the coolant has a significant conductivity, it will lead to a variety of conductive coolant-induced stack problems including shunt currents that reduce fuel efficiency, gas evolution (O₂ and H₂) in the header area creating increased pressure within the fuel cell stack requiring venting, coolant degradation, and oxygen degradation of stack components including coating blistering and corrosion acceleration.

The present inventors have recognized a need for improvements in liquid coolant technology for fuel cell stacks.

The present invention meets the above-mentioned need by providing an environmentally friendly, inexpensive, and readily available dielectric coolant for fuel cell stacks, which coolant is well suited for use in vehicles powered by fuel cell technologies. By “environmentally friendly” we mean that the dielectric coolant is a non-toxic, biodegradable material. Although the present invention is not limited to specific advantages or functionality, it is noted that because the coolant is a dielectric and does not allow for any ionic transport, it does not affect the stack components, and does not allow for any performance loss caused by shunt currents on the header area of the stack. Consequently, corrosion inhibitors need not be added to prohibit the dissolution of fuel cell components. Although the heat capacity of the dielectric coolant of the present invention is slightly less than aqueous-based coolants, the present coolant has a relatively low kinematic viscosity which enables it to be pumped at higher flow rates to remove waste heat without an appreciable increase in parasitic pumping power. Moreover, the relatively high boiling point of the dielectric coolant enables operating the fuel cell stack and coolant loop at higher temperatures (˜140° C.), increasing the capacity to exhaust heat from the radiator to the environment.

In one embodiment, the present invention provides a fuel cell configured to react fuel with oxygen to generate an electric current and at least one reaction product. The fuel cell comprises an electrochemical catalytic reaction cell configured to include a fuel flowpath, an oxygen flowpath, and a coolant flowpath fluidly decoupled from the fuel flowpath and the oxygen flowpath. The coolant flowpath defines a coolant isolation manifold that includes a fluid dielectric coolant, which comprises a vegetable oil-based dielectric fluid.

In another embodiment, the present invention provides a system comprising a fuel cell stack comprising a plurality of fuel cells, wherein each fuel cell is configured to react fuel with oxygen to generate an electric current and at least one reaction product. Each fuel cell comprises an electrochemical catalytic reaction cell configured to include a fuel flowpath, an oxygen flowpath, and a coolant flowpath fluidly decoupled from the fuel flowpath and the oxygen flowpath. The coolant flowpath defines a coolant isolation manifold that includes a fluid dielectric coolant, which comprises a vegetable oil-based dielectric fluid.

In still another embodiment, the system of the present invention further provides a vehicle body. The fuel cell stack is configured to at least partially provide the vehicle body with motive power.

In yet another embodiment, the present invention provides a method of cooling a fuel cell comprising providing a fuel cell configured to react fuel with oxygen to generate an electric current and at least one reaction product. The method comprises configuring the fuel cell to comprise an electrochemical catalytic reaction cell configured to include a fuel flowpath, an oxygen flowpath, and a coolant flowpath fluidly decoupled from the fuel flowpath and the oxygen flowpath. The method further comprises configuring the coolant flowpath to define a coolant isolation manifold including a fluid dielectric coolant, which comprises a vegetable oil-based dielectric fluid.

These and other features and advantages of the invention will be more fully understood from the following detailed description of the invention taken together with the accompanying drawings. It is noted that the scope of the claims is defined by the recitations therein and not by the specific discussion of features and advantages set forth in the present description.

### BRIEF DESCRIPTION OF THE DRAWINGS

The following detailed description of the embodiments of the present invention can be. best understood when read in conjunction with the following drawings, where like structure is indicated with like reference numerals and in which:

FIG. 1 is a schematic illustration of a system in accordance with the present invention;

FIG. 2 is a schematic illustration of a system further comprising a vehicle body in accordance with the present invention; and

FIG. 3 shows a current transient obtained on stainless steel coupons in the presence of a vegetable oil-based dielectric coolant in accordance with the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of the embodiments of the present invention.

### DETAILED DESCRIPTION OF SOME EMBODIMENTS OF THE INVENTION

In accordance with one embodiment of the present invention, a fuel cell is provided that is configured to react fuel (typically, gaseous hydrogen) with oxygen to generate an electric current and at least one reaction product. Among the other components of the fuel cell that will be described in further detail below, the fuel cell comprises a coolant flowpath that defines a coolant isolation manifold. The manifold includes a fluid dielectric coolant, which is employed to cool the fuel cell and increase the useful lifetime of its components.

The fluid dielectric coolant comprises a vegetable oil-based dielectric fluid, which can comprise at least one vegetable oil. Typically, the vegetable oil-based dielectric fluid comprises about 98.5% vegetable oil. The vegetable oil can be derived from plant matter and typically comprises mixed glycerides formed from a polyol backbone, such as glycerin, in which the constituent hydroxyl groups are esterified with an equal or nearly equal number of fatty acid molecules. Many useful vegetable oils are triglycerides, i.e., are glycerides having three fatty acid molecules chemically bonded to the glycerin backbone. Such triglycerides generally are of the formula:

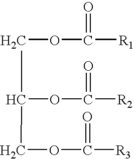

wherein R₁, R₂, and R₃ each, independently, is an alkyl or alkenyl group that may be straight-chained or branched, may be saturated or unsaturated, and may be unsubstituted or may be substituted with one or more functional or nonfunctional moieties. The vegetable oil can also be defined as an edible seed-based ester that can include fatty acid triglycerides comprising a linear chain of between 14 and 22 carbon atoms and between 0 and 3 double bonds.

Differences in the functional properties of vegetable oils generally are attributable to the variation in their constitutent fatty acid molecules. Several different fatty acids exist, including the following, all of which may be present in the vegetable oils of the present invention: myristic acid, palmitic acid, stearic acid, oleic acid, linoleic acid, linolenic acid, arachidic acid, eicosenoic acid, behenic acid, erucic acid, palmitiolic acid, docosadienoic acid, lignoseric acid, tetracossenoic acid, margaric acid, margaroleic acid, gadoleic acid, caprylic acid, capric acid, lauric acid, pentadecanoic acid, heptadecanoic acid, and combinations thereof. These fatty acid molecules can also vary in their degree of unsaturation and therefore can comprise both monounsaturated and polyunsaturated fatty acids, as well as saturated fatty acids, or combinations thereof. More particularly, the vegetable oil-based dielectric fluid of the present invention can comprise 23.8% ±0.1% monounsaturated fatty acids, 59.9% ±0.1% polyunsaturated fatty acids, and 15.7% ±0.1% saturated fatty acids.

Fatty acid molecules may be arranged on a polyol backbone in any number of ways, and each polyol can have one, two or several different constitutent fatty acid molecules. The three fatty acid molecules on a triglyceride molecule, for example, may be the same or may comprise two or three different fatty acid molecules. While the compositions of triglyceride compounds found in plant matter vary from species to species, and less so from strain to strain of a particular species, vegetable oil derived from a single strain of plant species generally will have the same fatty acid composition.

Every naturally occurring triglyceride has a unique set of properties. For example, some triglycerides are more susceptible to oxidation than are others. According to the present invention, it is typical to use oils having fatty acid molecules that include a component having at least one degree of unsaturation (i.e., at least one C═C double bond). This selection strikes a balance between the effects of oxidation with a desired reduction in the evolution of hydrogen gas. It has been found that oils containing monounsaturates oxidize less rapidly than do polyunsaturated oils and therefore are typically used in the present invention. Specific, representative, vegetable oils suitable for use in the present invention include the following: castor oil, coconut oil, corn oil, cottonseed oil, crambie oil, jojoba oil, lesquerella oil, linseed oil, olive oil, palm oil, rapeseed (canola) oil, safflower oil, sunflower oil, soya oil, veronia oil, and combinations thereof.

The vegetable oils which form the vegetable oil-based dielectric fluid of the present invention may be used alone or may be blended together with one or more other vegetable oils. In appropriate circumstances, a vegetable oil or vegetable oil blend may also be combined with one or more synthetic oils, including petroleum-derived mineral oils. When a vegetable oil or vegetable oil blend is combined with one or more synthetic oils, the amount and/or character of the non-vegetable oil component of the resulting blend should not interfere with the beneficial properties of the vegetable oil-based dielectric fluid. Thus, for example, any significant amount of a chlorinated fluid (aromatic chlorinated compounds such as trichlorobenzene or polychlorinated biphenyls) will negate many of the positive environmental attributes of the vegetable oil component. Where such blends are employed, the blend should contain no more than about 50 percent by weight of a petroleum-derived mineral oil. Alternatively, the blend can contain no more than about 30 percent by weight, or no more than about 20 percent by weight of such petroleum-derived mineral oil. Moreover, the vegetable oil-based dielectric fluid should be substantially free of chlorinated compounds, such that it contains less than about 20 percent by weight of a chlorinated fluid. Alternatively, the dielectric fluid can contain less than about 5 percent by weight or less than about 1 percent by weight of such chlorinated fluid. The vegetable oil-based dielectric fluid can further be “food grade”, i.e., that it not contain any component that is considered toxic or otherwise biologically hazardous.

The vegetable oil-based dielectric fluid has a substantially clear appearance and, where desired, may be pigmented or colored with a suitable dye or pigment. For example, the dielectric fluid can be tinted green in order to represent its environmentally friendly or “green” characteristics. Any known dye or pigment can be used for this purpose, and many are available commercially as food additives. The most useful dyes and pigments are those that are oil soluble.

The use of the vegetable oil-based dielectric fluid of the present invention as a coolant can extend the useful lifetime of the fuel cell, as unlike aqueous-based coolants, vegetable oil-based dielectric fluids will not degrade the stack components. Consequently, corrosion inhibitors need not be added to the fluid dielectric coolant of the instant invention.

Although other nondielectric, aqueous-based coolants have a higher heat capacity than the vegetable oil-based dielectric fluid of the present invention, the relatively low kinematic viscosity of the vegetable oil-based dielectric fluid enables it to be pumped at higher flow rates. According to the present invention, the vegetable oil-based dielectric fluid can have a viscosity between about 2 and about 15 cSt at 100° C., more particularly less than or about 9 cSt at 100° C., and less than or about 110 cSt at 40° C., more particularly less than or about 40 cSt at 40° C. In addition, the heat capacity (specific heat) of the vegetable oil-based dielectric fluid can be greater than or about 0.3 cal/g ° C., more particularly 0.45 (cal/gm/° C.) at 25° C., or 2.39 J/g/K at 100° C. (compared to 4.2 J/g/K for water) and 2.10 J/g/K at 50° C. This facilitates the removal of waste heat from the fuel cell without an appreciable loss in parasitic pumping power. The pumping power required to circulate the fluid dielectric coolant can be reduced by using bipolar plates possessing additional open coolant flowpaths.

The performance of the vegetable oil-based dielectric fluid of the present invention at low temperatures is important in some applications, such as in cold weather environments. Some vegetable oils do not, by themselves, have pour point values sufficiently low to be suitable for standard fuel cell coolant applications in cold environments. Vegetable oils, unlike some conventional mineral oils, may also solidify or gel when cooled to a temperature just slightly above their pour point temperature for an extended period of time. A typical fuel cell application requires that a coolant have a pour point below about −20° C. The vegetable oil-based dielectric fluids of the present invention can be modified to ensure flowability at moderately low temperatures typically encountered in cold weather environments (lower than about −20° C.). Suitable modification of the dielectric fluids include the addition of a pour point depressant, such that the vegetable oil-based dielectric fluid has a pour point of less than or about −20° C. Suitable pour point depressants include polyvinyl acetate oligomers and polymers, acrylic oligomers and polymers, and combinations thereof.

Low temperature characteristics may also be improved by judicious blending of oils. Certain oil blends, for example, have lower pour points than their individual constituent oils. For example, a blend of 25 percent by weight soya oil (I) with 75 percent by weight rapeseed oil (II) has a pour point of −24° C., compared with −15° C. and −16° C. for the constituent (I) and (II) oils respectively. Other vegetable oil blends that exhibit similarly advantageous reductions in pour points include: 25% soybean oil +75% oleate modified oil; 50% soybean oil +50% oleate modified oil; and 25% soybean oil +75% sunflower oil. It will be understood that this list of oil blends is not exhaustive and is offered merely to illustrate the nature of the invention.

On the other end of the temperature spectrum, the boiling point of the vegetable oil-based dielectric fluid is greater than or about 330° C. In addition, the vegetable oil-based dielectric fluid has fire resistant properties and exhibits a flash point greater than or about 300° C., more particularly about 316° C. closed cup and about 330° C. open cup, and a fire point well above the accepted minimum standard of 300° C. for both conventional and high fire point, “less-flammable” dielectric fluids. Less-Flammable fluids are recognized as a fire safeguard by Section 15 of the National Electrical Safety Code (Accredited Standards Committee C2). The vegetable oil-based dielectric fluid of the present invention meets the National Electrical Code Section 450-23 requirements as a listed less-flammable liquid. It is covered by OSHA Article §1910.305, Section 5(v). The dielectric fluid of the present invention is Factory Mutual Approved and UL Classified “Less-Flammable” per NEC Article 450-23, fitting the definition of a Listed Product per NEC. The vegetable oil-based dielectric fluid can comprise several oils, for example, which typically have fire points greater than or about 340° C., more particularly about 360° C. open cup. The thermal conductivity of the vegetable oil-based dielectric fluid coolant can be up to and including about 4.0×10⁻⁴ cal/(cm.sec.° C.) at 25° C.

The vegetable oil-based dielectric fluid of the present invention can be characterized by a dielectric strength of greater than or about 30 kV/100 mil gap, more particularly about 56 kV at 25° C. (0.080″ gap) or 47 kV at 25° C., a coefficient of expansion of about 7.4×10⁻⁴/° C. at 25° C., a dielectric constant or relative permittivity of about 3.2 at 25° C., a dissipation or power factor of less than or about 0.05% at 25° C., more particularly less than or about 0.03% at 25° C., a volume resistivity of about 30×10¹² Ω-cm at 25° C., and a break down potential of greater than or about 47 kV at 25° C. Moreover, the vegetable oil-based dielectric fluid can be further characterized by an impulse strength (sphere to sphere) of about 226 kV at 0.15″ gap, a gassing tendency of about −79 μL/min., a specific gravity of about 0.92 at 25° C., an interfacial tension of greater than or about 20 mN/m at 25° C., more particularly about 27 mN/m at 25° C., a pH of about 5.8, and a neutralization (acid) number of less than or about 0.07 mg KOH/g, more particularly about 0.022 mg KOH/g. The dielectric fluid exhibits a vapor pressure of less than or about 0.01 mm Hg at 20° C., has a solubility in water of less than or about 0.1%, and comprises less than or about 0.001 g/L of one or more volatile organic compounds.

Because of its negative effect on dielectric performance, the presence of water, a polar contaminant, in the vegetable oil-based dielectric fluid is undesirable. Water in the fluid tends to increase the rate of chemical breakdown of fatty acid esters in the vegetable oil in proportion to the amount of water available for such a reaction. The most obvious indicator of such reactions is a significant increase in the value of the neutralization number.

This problem can be compounded by the wide temperature range over which fuel cells must operate. It is known that the dielectric breakdown characteristics and other dielectric properties of mineral oils are directly related to the percent saturation of water present in the oil. The water saturation point of oil is in turn a function of temperature. As the saturation point is reached, dielectric strength falls rapidly. The water saturation point for mineral oils typically used as dielectric coolants is approximately 65 ppm at room temperature but over 500 ppm at about 100° C. Fuel cells exposed to a wide variation in temperature can suffer a fluctuation in the degree of water saturation in the dielectric fluid, and water that is dissolved or in vapor/liquid equilibrium at high operating temperatures (about 140° C.) can precipitate or condense when the temperature of the oil decreases.

In contrast to mineral oils, vegetable oils generally have much higher moisture saturation points; typically over 500 ppm at room temperature. Therefore, acceptable moisture levels in vegetable oils used in new fuel cell systems can be much higher than those for conventional mineral oils. Because the presence of water in vegetable oils can cause the additional breakdown of the constituent fatty acid esters, however, the moisture removal process used in the preparation of vegetable oil-based dielectric fluids should strive for moisture levels that reach below, as a percentage of saturation, those typically required for mineral oils. A moisture content of less than or about 200 ppm, more particularly 20 mg/kg, or a percent saturation of moisture of between about 5 and about 10 percent, more particularly between about 1 and about 2 percent, in the vegetable oil at room temperature is typical. Moreover, the vegetable oil-based dielectric fluid of the present invention is characterized by an air solubility of about 16% at 25° C. at 1 atmosphere. The oils also can be processed by filtration or other suitable means to remove particulate and other contaminants. This can be accomplished in a manner similar to the techniques for treating and processing convention mineral oil-based dielectric materials.

The long-term stability of the vegetable oil-based dielectric fluids of the present invention may be improved by utilizing any of the conventional methods known for improving the stability or performance of dielectric fluids. For example, one or more antioxidant or antimicrobial compounds may be added to the dielectric fluid. Useful antioxidant compounds for this purpose can be dissolved directly in the dielectric fluid comprising the vegetable oil and include, for example, BHA (butylated hydroanisole), BHT (butylated hydrotoluene), TBHQ (tertiary butylhydroquinone), THBP (tetrahydrobutrophenone), ascorbyl palmitate (rosemary oil), propyl gallate, and alpha-, beta- or delta-tocopherol (vitamin E). It is generally also desirable to include in the dielectric fluid one or more additives to inhibit the growth of microorganisms. Any antimicrobial substance that is compatible with the dielectric fluid may be blended into the fluid. In some cases, compounds that are useful as antioxidants also may be used as antimicrobials. It is known, for example, that phenolic antioxidants such as BHA also exhibit some activity against bacteria, molds, viruses and protozoa, particularly when used with other antimicrobial substances such as potassium sorbate, sorbic acid or monoglycerides. Vitamin E, ascorbyl palmitate and other known compounds also are suitable for use as antimicrobial additives to the dielectric fluid.

The vegetable oil-based dielectric fluid of the present invention is characterized as “environmentally friendly.” Accordingly, the dielectric fluid is specifically formulated to minimize health and environmental risk. It is made from a renewable, recyclable and reusable natural resource, commodity food grade seed-oils, and food grade performance enhancing additives, which are described herein. Genetically altered seed-oils are not required. The vegetable oil-based dielectric fluid can be employed as a replacement for petroleum-derived fluid coolants for fuel cells, which deplete non-renewable resources.

The dielectric fluid of the present invention is non-toxic, non-bioaccumulating, and readily biodegradable, such that it quickly and thoroughly biodegrades both in soil and aquatic environments. Its biodegradation rate meets the Environmental Protection Agency's (EPA) standard reference material (sodium citrate) and is deemed “ultimately biodegradable” per EPA Test OPPTS 835.3100. The vegetable oil-based dielectric fluid contains no petroleum, halogen, or silicone compounds, which can be potentially hazardous, and thus the fluid presents a reduced environmental impact in the event of an accidental spill. The fluid's ability to polymerize when thin layers are exposed to heat and airflow help prevent migration along the surface and into subsurface soils.

The vegetable oil-based dielectric fluid is characterized by a biochemical oxygen demand to chemical oxygen demand (BOD/COD) ratio of about 45%, a 5 day biochemical oxygen demand of greater than or about 200 ppm, a 21 day biodegradation rate of greater than or about 99%, a LC₅₀ of less than or about 250 mg/L, and achieved a zero mortality rate when tested pursuant to Trout Fly Acute Toxicity Test OECD G.L. 203.

In accordance with another embodiment of the present invention, a system is provided comprising a plurality of fuel cells combined to form a fuel cell stack. Each fuel cell within the stack is configured to react fuel with oxygen to generate an electric current and at least one reaction product. Included in the stack is a coolant flowpath, which defines a coolant isolation manifold. The manifold includes a fluid dielectric coolant that comprises a vegetable oil-based dielectric fluid.

The conductivity of the fluid dielectric coolant is considerably important when choosing a coolant for fuel cell stacks. This is primarily because of the stack design that employs a header area to distribute the reactive gasses as well as the coolant to the coolant flowpath. In this header area, an electric field of 10 V/cm is easily attained. Ionic contamination of aqueous coolants can increase the conductivity to unacceptable levels causing shunt currents in the header area.

However, the vegetable oil-based coolant of the present invention is a dielectric, which does not permit ionic transport. Consequently, even when contaminated, the vegetable oil-based dielectric fluid coolant does not affect the stack components and also does not allow for performance loss due to shunt current on the header area of the stack. And unlike ion exchange resins that thermally degrade prematurely at temperatures exceeding 90° C., the present dielectric coolant can operate without an ion exchanger at much greater temperatures in order to efficiently exhaust waste heat at the radiator.

The fuel cell and system of the present invention each further comprise an electrochemical catalytic reaction cell configured to include a fuel flowpath, an oxygen flowpath, and a coolant flowpath fluidly decoupled from the fuel flowpath and the oxygen flowpath. The fuel flowpath can comprise an anode flowpath configured to route fuel through at least a portion of each fuel cell. The electrochemical catalytic reaction cell can further comprise an anode in fluid communication with the anode flowpath, upon which a catalytic reaction with the fuel is configured to take place. In addition, the oxygen flowpath can comprise a cathode flowpath configured to route oxygen through at least a portion of each fuel cell. The electrochemical catalytic reaction cell can further comprise a cathode in fluid communication with the cathode flowpath and a catalytic reaction with the oxygen is configured to take place on the cathode. Moreover, a membrane can be disposed between the anode and the cathode such that electrolyte communication is established therebetween during operation of the fuel cell or system.

The fuel cell and system of the present invention, each comprising a coolant flowpath, can each further comprise a recirculation assembly comprising a recirculation flowpath, a pump, and a radiator. The coolant isolation manifold can further include an inlet and an outlet. The recirculation flowpath extends from the coolant isolation manifold inlet and fluidly connects the pump and radiator to the coolant isolation manifold outlet. The recirculation assembly is configured to circulate coolant throughout the coolant flowpath, thus drawing waste heat from the fuel cell or fuel cell stack and delivering it via the recirculation flowpath to the radiator. The radiator can be any radiator that is effective in removing heat from the heated dielectric coolant for recirculation back to the coolant isolation manifold.

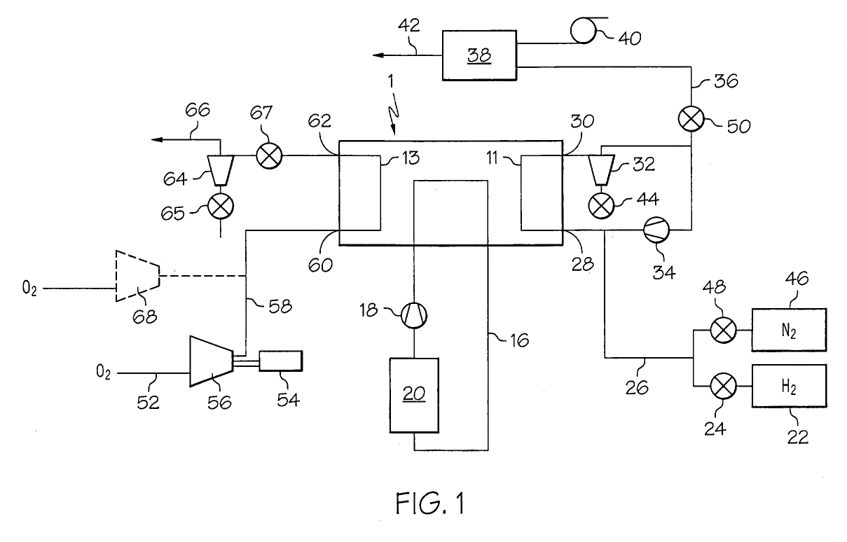

While not intending to limit the present invention to any particular fuel cell structure, referring now to FIG. 1, a schematic illustration of a typical fuel cell or system for use in accordance with the present invention is provided as an example. Fuel cell stack 1 includes a plurality of individual fuel cells that can be electrically connected in series, in parallel, or a combination of both. At the fuel side 11 of the fuel cell stack 1, fuel (typically, gaseous hydrogen H₂) can be fed from a supply 22 via a valve 24 and line 26 into the electrochemical catalytic reaction cell via the fuel flowpath, which is positioned within the fuel cell. The fuel therefore enters the fuel cell stack 1 at the inlet 28, while fuel exhaust gasses containing unconsumed hydrogen and water exit the fuel cell stack 1 at the outlet 30. The water that condenses out can be received in a collection receptacle 32, while a portion of the exiting hydrogen can be returned to the inlet 28 by means of a pump 34. The remaining fuel side exhaust gasses can be fed via a valve 50 and line 36 to a combustor device 38, where together with air from a fan 40, the fuel side exhaust gasses are burned such that the combustion of exhaust gasses, primarily nitrogen and water vapor, leave the fuel cell stack 1 via line 42. The water that has collected in the receptacle 32 can be drained periodically by means of a drain valve 44.

At the fuel side 11 of the fuel cell stack 1 there can also be a supply of nitrogen N₂ in a reservoir 46. When the fuel cell stack 1 is off, valve 24 can be closed and valve 48 can be opened in order to introduce nitrogen N₂ via line 26 into the fuel flowpath in the fuel cell in order to displace the hydrogen H₂ from the fuel cell. The hydrogen H₂ can then be burned under controlled conditions in the combustor 38, thereby reducing the danger of hydrogen H₂ accumulation in the fuel cell. The combustion device 38 need not be continuously in operation and can be isolated from the fuel side 11 circuit by means of the valve 50.

Oxygen O₂ enters the oxygen side 13 of the fuel cell stack 1 via line 52, and can be compressed by a compressor 56 that is driven by a motor 54. After passing through compressor 56, the oxygen O₂ passes through line 58 to the oxygen inlet 60, where it enters the electrochemical catalytic reaction cell within the fuel cell via the oxygen flowpath. The exhaust gas, which primarily consists of water vapor, nitrogen and oxygen, exits from the oxygen outlet 62 of the fuel cell stack 1, where water vapor can be collected in a receptacle 64, while the remaining exhaust gasses are vented to the atmosphere via line 66 and valve 67. An optional auxiliary compressor 68, which is also driven by a motor (not shown), or compressor 56 can be used to start up the system. As with the fuel side 11 of the system, a valve 65 can be used to selectively allow water collected in receptacle 64 to be drained from the system.

In accordance with the present invention, the recirculation assembly 16 is represented as a loop to ensure adequate cooling of the fuel cell stack 1 during system operation. The assembly 16 is autonomous relative to the fuel side 11 and the oxygen side 13 such that the dielectric coolant (a vegetable oil-based dielectric fluid) in the assembly 16 does not mix with the fluid generated by the reaction between the hydrogen H₂ and oxygen O₂ within the reaction cell. The assembly 16 further includes a closed recirculation flowpath with a pump 18 and a radiator 20.

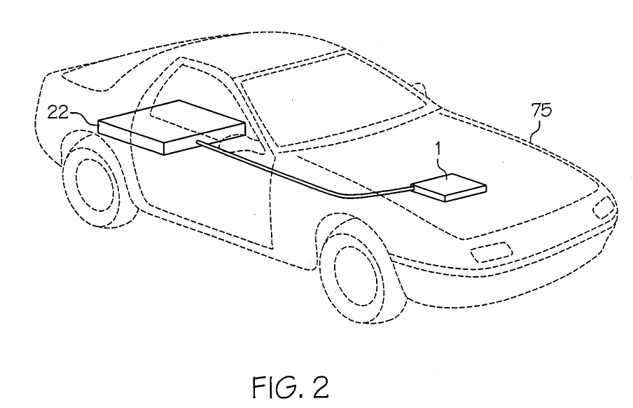

Referring now to FIG. 2, the system of the present invention can further comprise a vehicle body 75. The fuel cell stack 1, which can be embodied within the vehicle body 75, is configured to at least partially provide the vehicle body 75 with motive power. A supply 22 of fuel can be provided, which is typically gaseous hydrogen. Although the vehicle shown in FIG. 2 is a passenger automobile, it is contemplated that the vehicle can be any vehicle now known or later developed that is capable of being powered or propelled by a fuel cell system, such as, for example, automobiles (i.e., car, light- or heavy-duty truck, or tractor trailer), farm equipment, aircraft, railroad engines, etc. The system shown in FIG. 2 can be cooled by the vegetable oil-based dielectric fluid described herein, having properties which are environmentally friendly (i.e., are not toxic or otherwise biologically hazardous), and which are effective in reducing the occurrence of shunt current within the fuel cell stack 1.

In accordance with yet another embodiment of the present invention, a method of cooling a fuel cell is provided comprising providing a fuel cell that is configured as hereinbefore described and circulating the fluid dielectric coolant throughout the coolant isolation manifold, such that the fluid dielectric coolant draws heat from the fuel cell, producing a heated fluid dielectric coolant. The fluid dielectric coolant can comprise a vegetable oil-based dielectric fluid such as described in further detail above. The method further comprises circulating the heated fluid dielectric coolant from the coolant isolation manifold to the radiator via the recirculation flowpath, cooling the heated fluid dielectric coolant in the radiator, and returning the cooled fluid dielectric coolant to the manifold inlet.

In order that the invention may be more readily understood, reference is made to the following example, which is intended to illustrate the invention, but not limit the scope thereof.

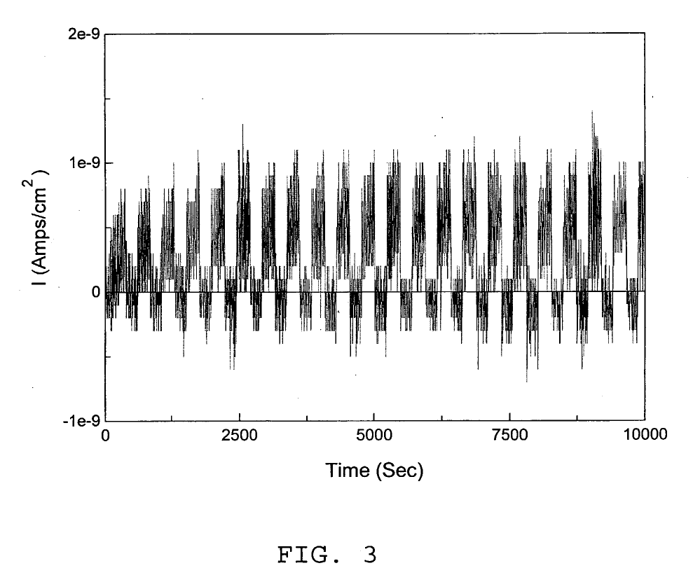

A current transient was obtained on 316L stainless steel coupons in the presence of Envirotemp® FR3™ coolant (available from Cooper Power Systems, Waukesha, Wis.) at an electric field (5 V/cm). FIG. 3 shows the relation between the shunt current and time measured at an applied potential of 5 V at 80° C. and that no measurable shunt current was detected.

While the invention has been described by reference to certain embodiments, is should be understood that numerous changes could be made within the spirit and scope of the inventive concepts described. Accordingly, it is intended that the invention not be limited to the disclosed embodiments, but that is have the full scope permitted by the language of the following claims.

What is claimed is:

1. A fuel cell configured to react fuel with oxygen to generate an electric current and at least one reaction product, wherein:
said fuel cell comprises an electrochemical catalytic reaction cell configured to include a fuel flowpath, an oxygen flowpath, and a coolant flowpath fluidly decoupled from said fuel flowpath and said oxygen flowpath; and
said coolant flowpath defines a coolant isolation manifold, and wherein said coolant isolation manifold includes a fluid dielectric coolant, said fluid dielectric coolant comprising a vegetable oil-based dielectric fluid.

2. The fuel cell of claim 1 wherein:
said fuel flowpath comprises an anode flowpath configured to route said fuel through at least a portion of said fuel cell; and
said oxygen flowpath comprises a cathode flowpath configured to route said oxygen through at least a portion of said fuel cell.

3. The fuel cell of claim 3 wherein said electrochemical catalytic reaction cell further comprises:
an anode in fluid communication with said anode flowpath and upon which a catalytic reaction with said fuel is configured to take place;
a cathode in fluid communication with said cathode flowpath and upon which a catalytic reaction with said oxygen is configured to take place; and
a membrane disposed between said anode and said cathode such that electrolyte communication is established therebetween during operation of said fuel cell.

4. The fuel cell of claim 1 wherein said vegetable oil-based dielectric fluid comprises at least one vegetable oil.

5. The fuel cell of claim 1 wherein said vegetable oil-based dielectric fluid comprises a blend of two or more vegetable oils.

6. The fuel cell of claim 1 wherein said vegetable oil-based dielectric fluid comprises a blend of one or more vegetable oils and one or more synthetic oils.

7. The fuel cell of claim 6 wherein said synthetic oil is a petroleum-derived mineral oil.

8. The fuel cell of claim 1 wherein said vegetable oil-based dielectric fluid comprises a blend of one or more vegetable oils and no more than about 50% by wt. of a petroleum-derived mineral oil.

9. The fuel cell of claim 1 wherein said vegetable oil-based dielectric fluid comprises a blend of one or more vegetable oils and no more than about 30% by wt. of a petroleum-derived mineral oil.

10. The fuel cell of claim 1 wherein said vegetable oil-based dielectric fluid comprises a blend of one or more vegetable oils and no more than about 20% by wt. of a petroleum-derived mineral oil.

11. The fuel cell of claim 1 wherein said vegetable oil-based dielectric fluid comprises about 98.5% vegetable oil.

12. The fuel cell of claim 1 wherein said vegetable oil-based dielectric fluid is substantially free of chlorinated compounds.

13. The fuel cell of claim 1 wherein said vegetable oil-based dielectric fluid is food grade.

14. The fuel cell of claim 1 wherein said vegetable oil-based dielectric fluid comprises a triglyceride of the formula: 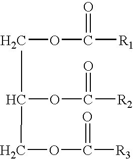
wherein R₁, R₂, and R₃ each, independently, is an alkyl or alkenyl group.

15. The fuel cell of claim 14 wherein said alkyl group comprises a group selected from straight-chained alkyl groups, branched alkyl groups, saturated alkyl groups, unsaturated alkyl groups, unsubstituted alkyl groups, substituted alkyl groups, and combinations thereof.

16. The fuel cell of claim 15 wherein said substituted alkyl groups comprise one or more functional or nonfunctional moieties.

17. The fuel cell of claim 14 wherein said alkenyl group comprises a group selected from straight-chained alkenyl groups, branched alkenyl groups, saturated alkenyl groups, unsaturated alkenyl groups, unsubstituted alkenyl groups, substituted alkenyl groups, and combinations thereof.

18. The fuel cell of claim 17 wherein said substituted alkenyl groups comprise one or more functional or nonfunctional moieties.

19. The fuel cell of claim 1 wherein said vegetable oil-based dielectric fluid comprises one or more fatty acid molecules that include at least one degree of unsaturation.

20. The fuel cell of claim 19 wherein said one or more fatty acid molecules are selected from the group consisting of myristic acid, palmitic acid, stearic acid, oleic acid, linoleic acid, linolenic acid, arachidic acid, eicosenoic acid, behenic acid, erucic acid, palmitiolic acid, docosadienoic acid, lignoseric acid, tetracossenoic acid, margaric acid, margaroleic acid, gadoleic acid, caprylic acid, capric acid, lauric acid, pentadecanoic acid, heptadecanoic acid, and combinations thereof.

21. The fuel cell of claim 1 wherein said vegetable oil-based dielectric fluid comprises monounsaturated fatty acids, polyunsaturated fatty acids, saturated fatty acids, or combinations thereof.

22. The fuel cell of claim 1 wherein said vegetable oil-based dielectric fluid comprises an edible seed-based ester.

23. The fuel cell of claim 22 wherein said edible seed-based ester includes fatty acid triglycerides comprising a linear chain of between 14 and 22 carbon atoms and between 0 and 3 double bonds.

24. The fuel cell of claim 1 wherein said vegetable oil-based dielectric fluid comprises a vegetable oil selected from the group consisting of castor oil, coconut oil, corn oil, cottonseed oil, crambie oil, jojoba oil, lesquerella oil, linseed oil, olive oil, palm oil, canola oil, safflower oil, sunflower oil, soya oil, veronia oil, and combinations thereof.

25. The fuel cell of claim 1 wherein said vegetable oil-based dielectric fluid further comprises an antioxidant compound.

26. The fuel cell of claim 25 wherein said antioxidant compound is selected from the group consisting of butylated hydroanisole; butylated hydrotoluene; tertiary butylhydroquinone; tetrahydrobutrophenone; ascorbyl palmitate; propyl gallate; alpha-, beta-, or delta-tocopherol; and combinations thereof.

27. The fuel cell of claim 1 wherein said vegetable oil-based dielectric fluid further comprises an antimicrobial substance.

28. The fuel cell of claim 1 wherein said vegetable oil-based dielectric fluid further comprises a dye or pigment.

29. The fuel cell of claim 28 wherein said dye or pigment is oil soluble.

30. The fuel cell of claim 1 wherein said vegetable oil-based dielectric fluid is characterized by a heat capacity of greater than or about 0.3 cal/g.° C.

31. The fuel cell of claim 1 wherein said vegetable oil-based dielectric fluid is characterized by a heat capacity of about 2.39 J/g/K at 100° C.

32. The fuel cell of claim 1 wherein said vegetable oil-based dielectric fluid is characterized by a heat capacity of about 2.10 J/g/K at 50° C.

33. The fuel cell of claim 1 wherein said vegetable oil-based dielectric fluid is characterized by a thermal conductivity of up to and including about 4.0×10⁻⁴ cal/(cm. sec.° C.) at 25° C.

34. The fuel cell of claim 1 wherein said vegetable oil-based dielectric fluid is characterized by a boiling point of greater than or about 330° C.

35. The fuel cell of claim 1 wherein said vegetable oil-based dielectric fluid is characterized by a flash point of greater than or about 300° C.

36. The fuel cell of claim 1 wherein said vegetable oil-based dielectric fluid is characterized by a fire point of greater than or about 340° C.

37. The fuel cell of claim 1 wherein said vegetable oil-based dielectric fluid is characterized by a pour point of less than or about −20° C.

38. The fuel cell of claim 1 wherein said vegetable oil-based dielectric fluid further comprises a pour point depressant.

39. The fuel cell of claim 38 wherein said pour point depressant is selected from the group consisting of polyvinyl acetate oligomers and polymers, acrylic oligomers and polymers, and combinations thereof.

40. The fuel cell of claim 1 wherein said vegetable oil-based dielectric fluid is characterized by a coefficient of expansion of about 7.4×10⁻⁴/° C. at 25° C.

41. The fuel cell of claim 1 wherein said vegetable oil-based dielectric fluid is characterized by a dielectric strength of greater than or about 30 kV/100 mil gap.

42. The fuel cell of claim 1 wherein said vegetable oil-based dielectric fluid is characterized by a dielectric constant of about 3.2 at 25° C.

43. The fuel cell of claim 1 wherein said vegetable oil-based dielectric fluid is characterized by a dissipation factor of less than or about 0.05% at 25° C.

44. The fuel cell of claim 1 wherein said vegetable oil-based dielectric fluid is characterized by a volume resistivity of about 30×10¹² Ω-cm at 25° C.

45. The fuel cell of claim 1 wherein said vegetable oil-based dielectric fluid is characterized by a break down potential of greater than or about 47 kV at 25° C.

46. The fuel cell of claim 1 wherein said vegetable oil-based dielectric fluid is characterized by an impulse strength of about 226 kV.

47. The fuel cell of claim 1 wherein said vegetable oil-based dielectric fluid is characterized by a gassing tendency of about −79 μL/min.

48. The fuel cell of claim 1 wherein said vegetable oil-based dielectric fluid is characterized by a specific gravity of about 0.92 at 25° C.

49. The fuel cell of claim 1 wherein said vegetable oil-based dielectric fluid is characterized by an interfacial tension of greater than or about 20 mN/m at 25° C.

50. The fuel cell of claim 1 wherein said vegetable oil-based dielectric fluid is characterized by a pH of about 5.8.

51. The fuel cell of claim 1 wherein said vegetable oil-based dielectric fluid is characterized by a neutralization number of less than or about 0.07 mg KOH/g.

52. The fuel cell of claim 1 wherein said vegetable oil-based dielectric fluid is characterized by a vapor pressure of less than or about 0.01 mm Hg at 20° C.

53. The fuel cell of claim 1 wherein said vegetable oil-based dielectric fluid is characterized by a solubility in water of less than or about 0.1%.

54. The fuel cell of claim 1 wherein said vegetable oil-based dielectric fluid comprises less than or about 0.001 g/L of one or more volatile organic compounds.

55. The fuel cell of claim 1 wherein said vegetable oil-based dielectric fluid is characterized by a viscosity of between about 2 and about 15 cSt at 100° C.

56. The fuel cell of claim 1 wherein said vegetable oil-based dielectric fluid is characterized by a viscosity of less than or about 9 cSt at 100° C.

57. The fuel cell of claim 1 wherein said vegetable oil-based dielectric fluid is characterized by a viscosity of less than or about 110 cSt at 40° C.

58. The fuel cell of claim 1 wherein said vegetable oil-based dielectric fluid is characterized by a viscosity of less than or about 40 cSt at 40° C.

59. The fuel cell of claim 1 wherein said vegetable oil-based dielectric fluid is characterized by a moisture content of less than or about 200 ppm.

60. The fuel cell of claim 1 wherein said vegetable oil-based dielectric fluid is characterized by a percent saturation of moisture of between about 5 and about 10%.

61. The fuel cell of claim 1 wherein said vegetable oil-based dielectric fluid is characterized by a percent saturation of moisture of between about 1 and about 2%.

62. The fuel cell of claim 1 wherein said vegetable oil-based dielectric fluid is characterized by an air solubility of about 16% at 25° C. at 1 atmosphere.

63. The fuel cell of claim 1 wherein said vegetable oil-based dielectric fluid is characterized by a biochemical oxygen demand to chemical oxygen demand ratio of about 45%.

64. The fuel cell of claim 1 wherein said vegetable oil-based dielectric fluid is characterized by a 5 day biochemical oxygen demand of greater than or about 200 ppm.

65. The fuel cell of claim 1 wherein said vegetable oil-based dielectric fluid is characterized by a 21 day biodegradation rate of greater than or about 99%.

66. The fuel cell of claim 1 wherein said vegetable oil-based dielectric fluid is characterized by a LC₅₀ of less than or about 250 mg/L.

67. The fuel cell of claim 1 wherein
said fuel cell further comprises a recirculation assembly, said recirculation assembly comprising a recirculation flowpath, a pump, and a radiator,
said coolant isolation manifold further includes an inlet and an outlet, and
said recirculation flowpath fluidly connects said coolant isolation manifold inlet and said coolant isolation manifold outlet.

68. A system comprising:
a fuel cell stack comprising a plurality of fuel cells, wherein each said fuel cell is configured to react fuel with oxygen to generate an electric current and at least one reaction product, and wherein:
each said fuel cell comprises an electrochemical catalytic reaction cell configured to include a fuel flowpath, an oxygen flowpath, and a coolant flowpath fluidly decoupled from said fuel flowpath and said oxygen flowpath; and
said coolant flowpath defines a coolant isolation manifold, and wherein said coolant isolation manifold includes a fluid dielectric coolant, said fluid dielectric coolant comprising a vegetable oil-based dielectric fluid.

69. The system of claim 68 wherein:
said fuel flowpath comprises an anode flowpath configured to route said fuel through at least a portion of each said fuel cell; and
said oxygen flowpath comprises a cathode flowpath configured to route said oxygen through at least a portion of each said fuel cell.

70. The system of claim 69 wherein said electrochemical reaction cell further comprises:
an anode in fluid communication with said anode flowpath and upon which a catalytic reaction with said fuel is configured to take place;
a cathode in fluid communication with said cathode flowpath and upon which a catalytic reaction with said oxygen is configured to take place; and
a membrane disposed between said anode and said cathode such that electrolyte communication is established therebetween during operation of each said fuel cell.

71. The system of claim 68 wherein
said fuel cell stack further comprises a recirculation assembly, said recirculation assembly comprising a recirculation flowpath, a pump, and a radiator,
said coolant isolation manifold further includes an inlet and an outlet, and
said recirculation flowpath fluidly connects said coolant isolation manifold inlet and said coolant isolation manifold outlet.

72. The system of claim 68 wherein said system further comprises:
a vehicle body, wherein said fuel cell stack is configured to at least partially provide said vehicle body with motive power.

73. A method of cooling a fuel cell comprising:
providing a fuel cell configured to react fuel with oxygen to generate an electric current and at least one reaction product;
configuring said fuel cell to comprise an electrochemical catalytic reaction cell configured to include a fuel flowpath, an oxygen flowpath, and a coolant flowpath fluidly decoupled from said fuel flowpath and said oxygen flowpath; and
configuring said coolant flowpath to define a coolant isolation manifold, said coolant isolation manifold including a fluid dielectric coolant, said fluid dielectric coolant comprising a vegetable oil-based dielectric fluid.

74. The method of claim 73 further comprising:
configuring said fuel flowpath to comprise an anode flowpath configured to route said fuel through at least a portion of said fuel cell; and
configuring said oxygen flowpath to comprise a cathode flowpath configured to route said oxygen through at least a portion of said fuel cell.

75. The method of claim 74 further comprising:
configuring said electrochemical catalytic reaction cell to further comprise:
an anode in fluid communication with said anode flowpath and upon which a catalytic reaction with said fuel is configured to take place;
a cathode in fluid communication with said cathode flowpath and upon which a catalytic reaction with said oxygen is configured to take place; and
a membrane disposed between said anode and said cathode such that electrolyte communication is established therebetween during operation of said fuel cell.

76. The method of claim 73 further comprising:
providing a recirculation assembly, said recirculation assembly comprising a recirculation flowpath, a pump, and a radiator, wherein said coolant isolation manifold further includes an inlet and an outlet;
configuring said recirculation assembly so that said recirculation flowpath fluidly connects said coolant isolation manifold inlet and said coolant isolation manifold outlet;
circulating said fluid dielectric coolant throughout said coolant isolation manifold, whereby said fluid dielectric coolant draws heat from said fuel cell to produce a heated fluid dielectric coolant; and
circulating said heated fluid dielectric coolant from said coolant isolation manifold outlet to said radiator via said recirculation flowpath, whereby said heated fluid dielectric coolant is cooled and returned to said coolant isolation manifold inlet.
